(19) United States
(12) Patent Application Publication
(10) Pub. No.: US 2015/0356547 A1
(43) Pub. Date: Dec. 10, 2015

(54) SYSTEM AND METHOD FOR PROVIDING TIPPING AND REVIEW SERVICES VIA A MOBILE DEVICE

(71) Applicant: Lutfi Abed, San Jose, CA (US)

(72) Inventor: Lutfi Abed, San Jose, CA (US)

(21) Appl. No.: 14/296,689

(22) Filed: Jun. 5, 2014

(51) Int. Cl. G06Q 20/32; G06F 17/30

(52) U.S. Cl. CPC G06Q 20/3221; G06F 17/3053

(57) ABSTRACT

Embodiments of the present invention are generally directed towards the provision of tipping and reviews via mobile computing devices. Specifically, embodiments of the present invention are directed to providing systems and methods for the provision of tips to service providers through an instant and easy process whereby a tipper can utilize their mobile computing device to quickly identify the individual to be tipped and process a tip transaction via the same mobile computing device. Further embodiments of the present invention allow for the tipper to provide reviews and/or ratings of the tipped individual which may be utilized by other components of the system for a variety of purposes.

### FIELD OF THE INVENTION

Embodiments of the present invention are generally directed towards the provision of tipping and reviews via mobile computing devices. Specifically, embodiments of the present invention are directed to providing systems and methods for the provision of tips to service providers through an instant and easy process whereby a tipper can utilize their mobile computing device to quickly identify the individual to be tipped and process a tip transaction via. the same mobile computing device. Further embodiments of the present invention allow for the tipper to provide reviews and/or ratings of the tipped individual which may be utilized by other components of the system for a variety of purposes.

### BACKGROUND

More and more individuals these days are moving away from using paper or other flat currency in lieu of non-cash payment means, such as credit cards, debit cards, electronic wallets, proprietary payment means (e.g., electronic toll payment devices, key fobs) and other electronic payment means. One ramification of this is that individuals carry less physical cash on them at any given time.

Cash has long been a convenient way to execute monetary transactions quickly and without need for potentially length transaction settlement processes. Non-cash payment means almost always require some form of validation and authorization process and generally require both payor and payee to have a compatible validation and authorization system. For instance, with regards to credit card transactions, the payor must have a credit card and the payee generally needs some physical or electronic payment gateway (e.g., credit card swipe machine) to effect the transaction. The problem being that not every payee has a compatible validation and authorization system available to them at all times.

One group of individuals that has suffered from the move from cash to non-cash payment means are service providers, such as waiters, delivery persons, bartenders, bellhops, doormen, cleaning people, and other individuals who rely on cash payments from patrons to supplement their income. Since fewer individuals carry cash, and these service providers do not generally have easily accessible payment validation systems, these service providers do not receive compensation they would otherwise receive as those they provide services to have no immediate means to compensate the service provider. This results in great loss of compensation for these service providers.

Further, since service providers are crucial to many organizations, and given that the quality of service providers varies greatly, even within the same organization, there is a need to ensure these service providers are regularly reviewed and evaluated. No one is in a better position to review and evaluate a service provider other than those who receive the services. Therefore, it is a relevant point of inquiry when providing compensation for a service (i.e., tipping) that a service recipient be invited to review their service provider. However, there is no ideal way to do this currently available in the art.

Current service provider review methods focus on providing a name or a paper form for submission by a recipient of a service. After completion of a service by a service provider, the recipient is requested to fill out and return the paper form or otherwise comment on their service provider. However, this is not always convenient for the service recipient and therefore may not be completed by the recipient. Further, these systems favor poor reviews as those receiving good or average service are less likely to complete reviews than those with poor experiences.

Therefore, there is need in the art for systems and methods for the provision of tips and reviews to service providers through non-cash means and associate those reviews at the organizational level such that organizations can use these reviews to evaluate service provider performance. These and other features and advantages of the present invention will be explained and will become obvious to one skilled in the art through the summary of the invention that follows.

### SUMMARY OF THE INVENTION

Accordingly, it is an aspect of the present invention to provide systems and methods for the provision of tips and reviews to service providers through non-cash. means.

According to an embodiment of the present invention, a system for providing tips to service providers through non-cash means includes: a tip processing module, comprising computer-executable code stored in non-volatile memory, a communications module, a processor, one or more storage mediums, wherein said tip processing module, said communications module, said processor, and said one or more storage mediums are operably connected and are configured to: receive a tip transaction request from a mobile computing device; retrieve a tip recipient identifier based on information contained in said transaction request; identify a tip amount and a payment source based on information contained in said transaction request; process a financial transaction on said payment source for the tip amount; transfer funds to a payment account associated with said tip recipient identifier; and send transaction confirmation to said mobile computing device.

According to an embodiment of the present invention, the tip processing module, said communications module, said processor, and said one or more storage mediums are further configured to: retrieve an organization identifier associated with said tip recipient identifier; retrieve a review format associated with said organization identifier; provide said review format to said mobile computing device; receive review response from said mobile computing device; and associate said review response with said organization identifier and said tip recipient identifier.

According to an embodiment of the present invention, the tip processing module, said communications module, said processor, and said one or more storage mediums are further configured to: generate a tip recipient review rating based in part on said review response, wherein said tip recipient review rating is a cumulative scoring based on a plurality of reviews received and associated with said tip recipient; and provide said review rating to an account associated with said organization identifier.

According to an embodiment of the present invention, the tip processing module, said communications module, said processor, and said one or more storage mediums are further configured to transfer a portion of the tip amount to an operating account associated with the system.

According to an embodiment of the present invention, the tip processing module, said communications module, said processor, and said one or more storage mediums are further configured to: generate a tax amount associated with said tip amount; and deduct said tax amount from said tip amount prior to transferring funds.

According to an embodiment of the present invention, the tip processing module, said communications module, said processor, and said one or more storage mediums are further configured to provide historical transaction reporting to an account associated with said tip recipient identifier.

According to an embodiment of the present invention, the tip processing module, said communications module, said processor, and said one or more storage mediums are further configured to generate a unique code for said tip recipient identifier for use in identifying a tip recipient, wherein the unique code is selected from the group comprising a quick response code, a bar code, an alphanumeric code and a unique visual code.

According to an embodiment of the present invention, a method for providing tips to service providers through non-cash means includes the steps of: receiving a tip transaction request from a mobile computing device; retrieving a tip recipient identifier based on information contained in said transaction request; identifying a tip amount and a payment source based on information contained in said transaction request; processing a financial transaction on said payment source for the tip amount; transferring funds to a payment account associated with said tip recipient identifier; and sending transaction confirmation to said mobile computing device.

According to an embodiment of the present invention, the method further includes the steps of: retrieving an organization identifier associated with said tip recipient identifier; retrieving a review format associated with said organization identifier; providing said review format to said mobile computing device; receiving review response from said mobile computing device; and associating said review response with said organization identifier and said tip recipient identifier.

According to an embodiment of the present invention, the method further includes the steps of: generating a tip recipient review rating based in part on said review response, wherein said tip recipient review rating is a cumulative scoring based on a plurality of reviews received and associated with said tip recipient; and providing said review rating to an account associated with said organization identifier.

According to an embodiment of the present invention, the method further includes the step of transferring a portion of the tip amount to an operating account associated with the system.

According to an embodiment of the present invention, the method further includes the steps of: generating a tax amount associated with said tip amount; and deducting said tax amount from said tip amount prior to transferring funds.

According to an embodiment of the present invention, the method further includes the step of providing historical transaction reporting to an account associated with said tip recipient identifier.

According to an embodiment of the present invention, the method further includes the step of generating a unique code for said tip recipient identifier for use in identifying a tip recipient, wherein the unique code is selected from the group comprising a quick response code, a bar code, an alphanumeric code and a unique visual code.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a system diagram, in accordance with an embodiment of the present invention;

FIG. 3 illustrates a system diagram, in accordance with an embodiment of the present invention;

FIG. 4A illustrates a schematic of a system for providing tipping and review services via a mobile device, in accordance with an embodiment of the present invention;

FIG. 4B illustrates a schematic of a system for providing tipping and review services via a mobile device, in accordance with an embodiment of the present invention;

FIG. 5 is a process flow of an exemplary method in accordance with embodiments of the present invention; and

FIG. 6 is a process flow of an exemplary method in accordance with embodiments of the present invention.

### DETAILED SPECIFICATION

Embodiments of the present invention are generally directed towards the provision of tipping and reviews via mobile computing devices. Specifically, embodiments of the present invention are directed to providing systems and methods for the provision of tips to service providers through an instant and easy process whereby a tipper can utilize their mobile computing device to quickly identify the individual to be tipped and process a tip transaction via the same mobile computing device. Further embodiments of the present invention allow for the tipper to provide reviews and/or ratings of the tipped individual which may be utilized by other components of the system for a variety of purposes.

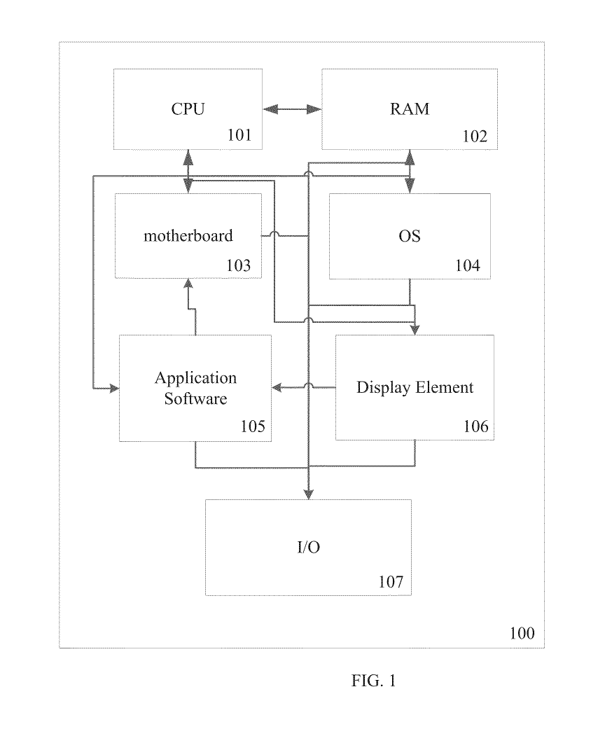

According to an embodiment of the present invention, the system and methods described herein may be accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory) 103, an operating system (OS) 104, one or more application software 105, one or more display elements 106 and one or more input/output devices/means 107. Examples of computing devices usable with embodiments of the present invention include, but are not limited to, personal computers, smart phones, laptops, mobile computing devices and tablet PCs and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet, cellular data networks). In accordance with the previous embodiment, the system may receive data from one or more servers or other computing devices communicatively connected across one or more LANs and/or WANs. One of ordinary skill in the art would appreciate that there are numerous manners in which the system could connected and configured to receive and transmit (where applicable) data and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

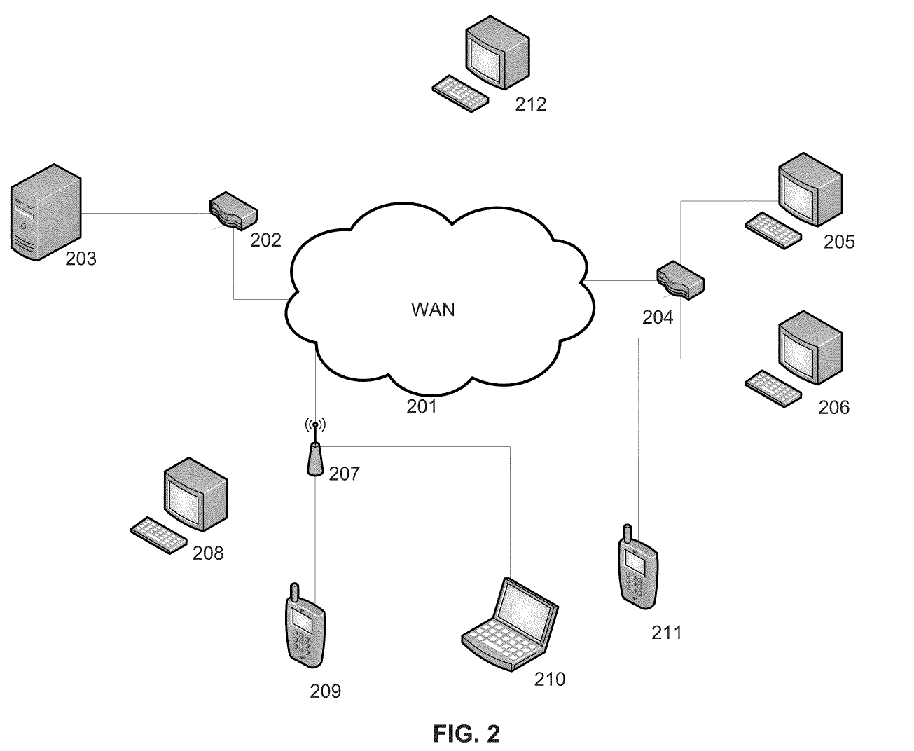

Referring to FIG. 2, a schematic overview of a system in accordance with an embodiment of the present invention is shown. Connection to such networks may be required or desirable for mobile computing device 211 to receive data from any number of sources required for generation of the user interface in accordance with embodiments of the present invention. According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information with the mobile computing device 211 or with other computing devices for use with embodiments of the system, and embodiments of the present invention are contemplated for use with any method for connecting to networks for the purpose of exchanging information. Further, while this application refers to high speed connections, embodiments of the present invention may be utilized with connections of any speed.

Components of the system (e.g., mobile computing device 211) may connect to data server 203 via Network 201 or other network in numerous ways. For instance, a component may connect to the system: i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a mobile computing device 211 may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

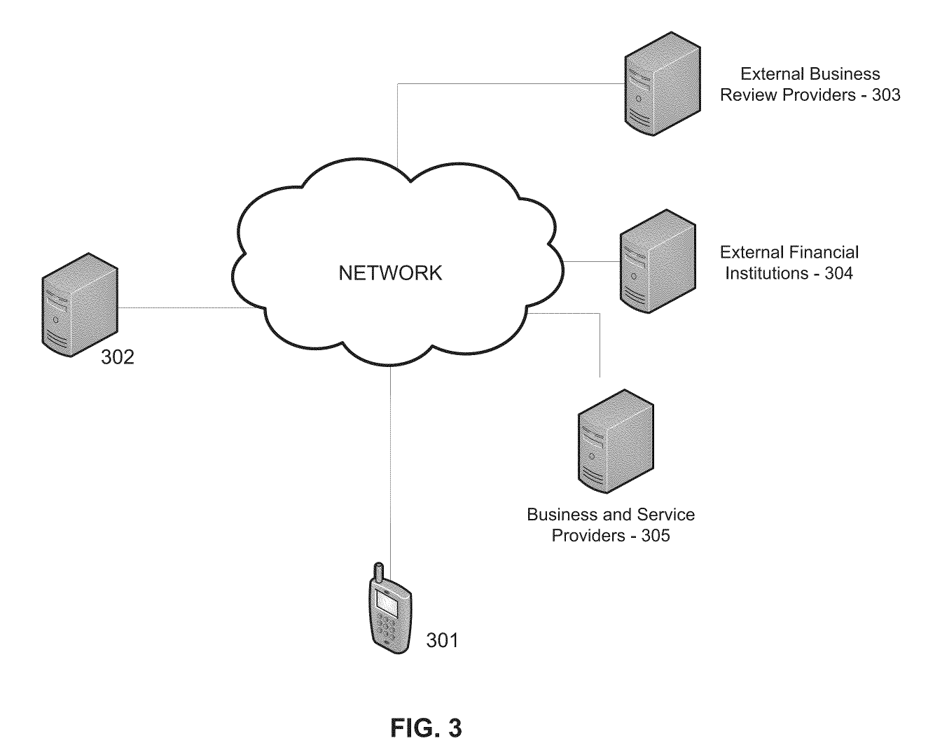

Turning now to FIG. 3, a continued schematic overview of a system in accordance with an embodiment of the present invention is shown. In FIG. 3, the system is shown as it may interact with users and other third party networks or APIs. For instance, a user of a mobile device 301 may be able to connect to application server 302. Application server 302 may be able to enhance or otherwise provide additional services to the user by transmitting and receiving information from one or more of an external business review provider API/website or other third party system 303, an external financial institution 304, one or more business and service providers 305 or any combination thereof. Additionally, application server 302 may be able to enhance or otherwise provide additional services to an external business review provider API/website or other third party system 303, an external financial institution 304, one or more business and service providers 305 by providing information to those entities that is stored on a database that is connected to the application server 302. One of ordinary skill in the art would appreciate how accessing one or more third-party systems could augment the ability of the system described herein, and embodiments of the present invention are contemplated for use with any third-party system.

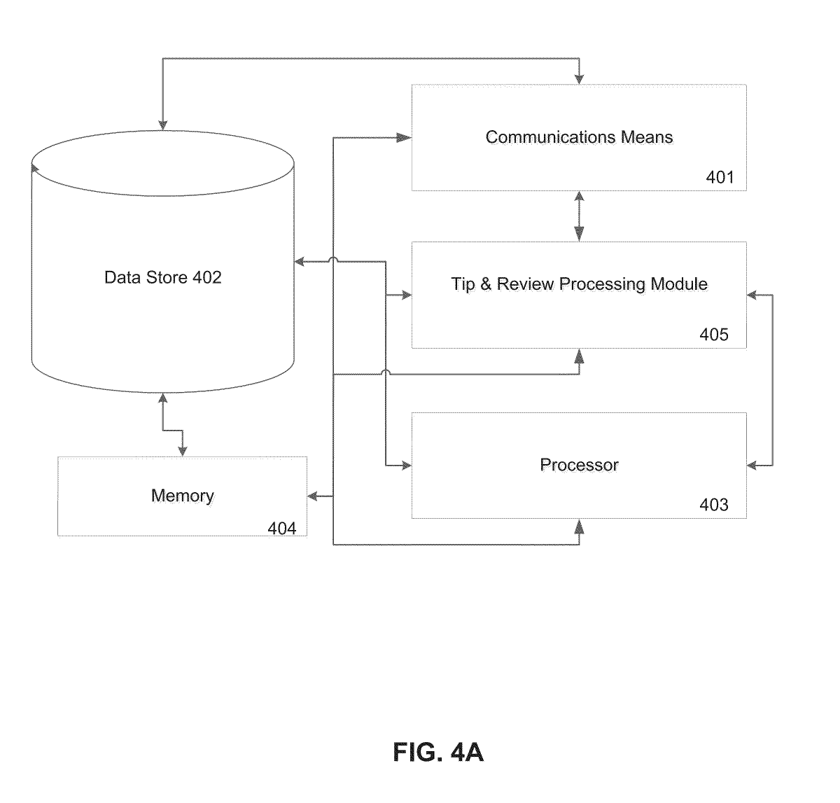

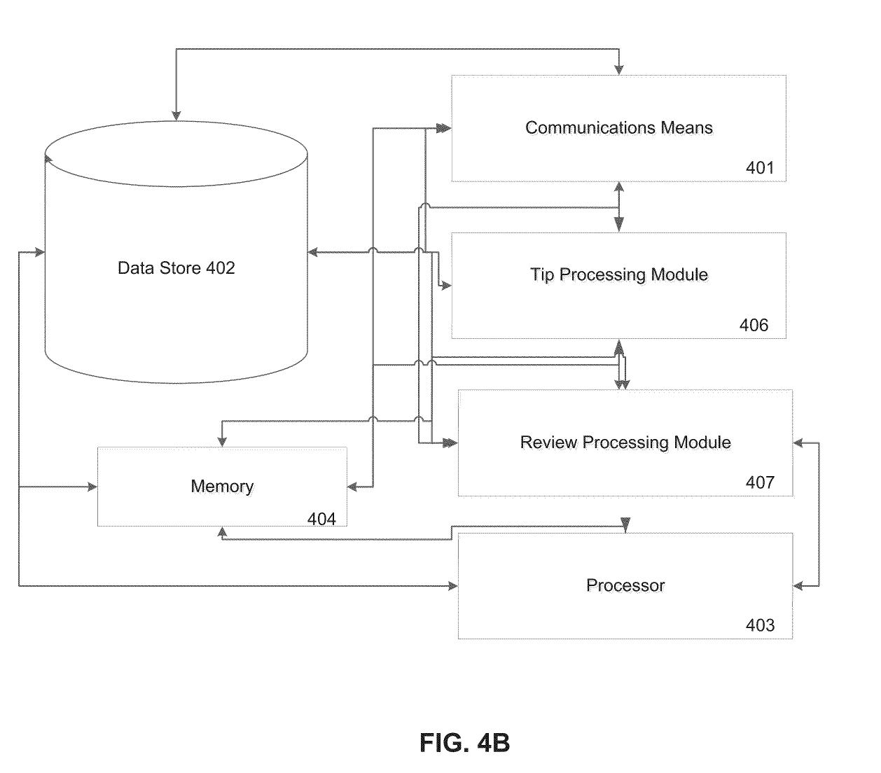

Turning to FIG. 4A, according to an embodiment of the present invention, a system for providing tipping and review services via a mobile device is comprised of one or more communications means 401, one or more data stores 402, a processor 403, memory 404, and a tip and review processing module 405. In FIG. 4B, according to an embodiment of the present invention, a system for providing tipping and review services via a mobile device is comprised of one or more communications means 401, one or more data stores 402, a processor 403, memory 404, a tip processing module 406, and a review processing module 407. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data over one or more networks. Appropriate communications means may include, but are not limited to, wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

According to an embodiment of the present invention, the display element of the system may be, for instance, any type of display that is capable of displaying information to a user. In some embodiments, the display element may also be used as a user interface through which a user both receives information and enters information about a review. in a preferred embodiment, the system is configured to display and collect feedback through a user interface presented on a display element, such as a screen of a smartphone or tablet PC. Display elements may include, but are not limited to, e-ink screens, heads-up displays (e.g., presented on wearable display elements such as glasses), wearable displays (e.g., watches), smartphone displays, tablet PC displays, or any combination thereof. One of ordinary skill in the art would appreciate that there are numerous display elements that might be utilized with embodiments of the present invention, and embodiments of the present invention are contemplated for use with any display element. For certain elements of the system, such as backend servers and middleware servers, no display element may be required. For these components, interaction is generally conducted through one or more remote access terminal connections or via one or more application program interfaces (APIs).

According to an embodiment of the present invention, the tip processing module portion of the system is configured to receive and process tip requests and other administrative features (e.g., registration, unique code generation) to be provided by the system. The tip processing module generally works in conjunction with the communication means and other components of the system to receive tip requests generated by users of the system via a mobile computing device. In preferred embodiments, the tip requests are generated by a mobile computing device of a user that has been pre-registered and had one or more payment sources associated with the registered user account. In this manner, the tip request can contain not only an identifier used for identifying the individual who should receive a tip, but also a tip amount and a selected payment source for the tip. This and other features are further described below. Payment sources include, but are not limited to, credit cards, debit cards, prepaid accounts, PayPal accounts, ACH transfer accounts, e-check services, direct bank account linking and any combination thereof. One or ordinary skill in the art would appreciate that there are numerous types of payment sources that could be utilized with embodiments of the present invention, and embodiments of the present invention are contemplated for use with any appropriate payment source type.

According to an embodiment of the present invention, the review processing module portion of the system is configured to provide features and functionality with respect to reviews associated with a service provider and/or one or more organizations. The review processing module generally works in conjunction with the communications means and other components of the system to provide service provider review and rating functionality. For instance, organizations that employ or contract with service providers may associate the service provider with their organization and when a user of the system submits a tip to the service provider, the system may retrieve a formatted review questionnaire or other review form for completion by the user who received service from the service provider. This allows for organizations to not only associate reviews with particular service providers, but also customize their questions or ratings based on the particular needs of the organization or position held by the service provider. These and other features are further described below.

According to an embodiment of the present invention, the system is configured to provide services to both users who wish to provide tips or other payments to service providers and those service providers who wish to receive tips via non-cash payments. The system is generally effected through a plurality of computing devices, with one portion being a mobile computing device operated by an end user wishing to make tips and provide service provider reviews via the system and the second portion being a server or other software as a service associated back end capable of receiving and processing the requests to submit tips and reviews.

From the aspect of the service provider, the system may allow the service provider to register with the system by provision of identifying information. Identifying information may include, but is not limited to, name, address, user name, password, email address, contact information, or any combination thereof. The system may also allow the service provider to provide banking or other financial institution information for associating the service provider's financial accounts with the system for receipt of tips or other monetary transfers from the system.

Once the service provider is registered with the system, the system is generally configured to provide the service provider with one or more unique codes for use with receiving tips through use of the system. Unique codes may include, but are not limited to, bar codes, quick response (QR) code, visually unique codes, alphanumeric codes, electronic codes, or any combination thereof. With respect to electronic codes, these codes may be used by service providers wishing to receive tips through the use of a mobile computing device via communication with a mobile computing device of a tipping user. For instance, electronic codes may include a unique identifier (e.g., GUID) which can be used to identify the service provider via a software application on the service provider's mobile computing device communicatively connected to a software application on a tipper's mobile computing device. Appropriate communication connections may include, but are not limited to, ad-hoc wireless networks, near field communication (NFC) transfer, radio frequency identifier (RFID) communication, BLUETOOTH transfer, or any combination thereof. One of ordinary skill in the art would appreciate that there are numerous methods for providing communication connections between two mobile computing devices, and embodiments of the present invention are contemplated for use with any appropriate communications connection type.

When a service provider is registered, the service provider may also be further associated with one or more organizations. Organizations may be any employer or contractor of one or more service providers. Examples of organizations include, but are not limited to, restaurants, spas, taxi or limousine service providers, hotels, bars, resorts, nightclubs, casinos, cruise ship operators, airlines, cleaning services, or any combination thereof. One or ordinary skill in the art would appreciate that there are numerous types of organizations that could utilize embodiments of the present invention, and embodiments of the present invention are contemplated for use by any type of organization. Organizations may be required to register with the system before receiving the ability to associate service providers therewith and have other features provided by the system offered to the organization.

Client Viewpoint

With respect to clients/users, the system may also require registration prior to utilization. Registration for a client may require identifying information, similar to that of service providers. Further, the system may allow users to register one or more payment sources for utilization with tip transactions. Registered payment sources may be stored locally on the mobile computing device of the user, or remotely with portions of the system, such as in a secured data store and retrieved when needed to commit a tip transaction. Storing payment sources allows the system to provide fast and convenient tipping or service providers.

After registration is complete, a registered service provider may provide their unique code to any client that utilizes the system. In preferred embodiments, the service provider will provide their unique code to the client for use with their mobile computing device. Whether by inputting a code into an application on the client's mobile computing device, scanning a QR code, barcode or other visual image, or through pairing with the service provider's mobile computing device, the unique code is received by the mobile computing device of the client and the client can begin the tip transaction at their convenience.

According to an embodiment of the present invention, the client can either submit a tip transaction immediately or any time in the future. This allows the client the ability to leave a tip they feel comfortable with or otherwise remove the pressure to provide a certain level of tip in the presence of the service provider. Further, it allows clients who are too busy to process a tip transaction immediately, the ability to do so at a later time when it is more convenient for them. In these embodiments, the client's mobile computing device may store the unique code and associate the unique code with a service provided, an organization, or other identifying information of the service provider such that the client is able to later identify who the unique code belongs to. In certain embodiments, the system may retain the unique code until such time that (i) a tip payment is made, (ii) the client submits a request to delete the tip transaction, or (iii) a specified amount of time elapses.

Similarly, any review form completion or submission provided by an organization associated with the service provider may be completed at a time most convenient to the client. This allows clients the ability to address a review form at their leisure and does not force a client to make quick and thoughtless comments in order simply to complete the process.

According to an embodiment of the present invention, the system can be utilized to provide clients with a list of service providers in their proximity that utilize the system. This can be done by interfacing global positioning system (GPS) data or other location data available to the system from the client's remote computing device and referencing service providers in the vicinity of the client's mobile computing device while providing the client a list of such service providers. In certain embodiments, the system can be utilized to provide a graphical user interface (GUI) or GUI data to the mobile computing device of the client which represents the location of such compatible service providers (and organizations where applicable) on a map or other illustrative display element. One of ordinary skill in the art would appreciate that there are numerous methods for providing identification of locations using location based services, and embodiments of the present invention are contemplated for use with any appropriate location based service and associated identification means.

According to an embodiment of the present invention, client's may also be provided with information on past tips, past service providers and other information in order to give the client an outlook of their transactions and reviews provided by way of the system. The client may also be able to transfer the information to one or more remote computing devices for use in other processes (e.g., accounting software for tax purposes). The user may also save and store or block service providers or organizations that the client believes has provided superior or inferior services in the past, thereby allowing the client to personalize their experience in utilizing the system. In certain embodiments, the client may be able to organize their stored or blocked service providers in various GUIs, such as favorites lists, blocked lists, or any similar display (e.g., tabbed windows for each). Further, service providers may be added to such lists by provision of a unique code or scanning of a code and service providers may be added whether or not a tip transaction was ever completed by the client.

In certain embodiments, the system may not require the client to register. In these embodiments, the client simply needs to have an appropriate application or other software component installed on their mobile computing device that is capable of accessing the service. Tips may be provided on an anonymous or unregistered basis. These tip requests may require the client to enter or store payment source information on their mobile computing device, as opposed to storing or maintaining them with the system. Further, these embodiments may not allow access to historical or other data that would need registration or continuity of accounting to provide.

In certain embodiments, the system may provide clients the ability to see other tip transactions that are occurring around them. In this manner, the clients can see average tip amount, average tip percentage based on total service rendered, or other metrics of tipping in the local vicinity. In preferred embodiments using this feature, the system will provide this tipping information anonymously in order not to identify the other tippers or service providers associated with the tips. The system may be configured to provide reviews of organizations and particular service providers as well, but these features need not be anonymous as it may be relevant to the client's usage of a particular organization or service provider. In certain embodiments, the service provider, the client or both may allow their tips to be made public.

In certain embodiments, the system may provide clients the ability to use promotional codes to provide additional tip functionality or to encourage tipping and utilization of the system. Promotional codes may be, for instance, a unique code assigned to each client which can be utilized in order for the system to match the client's tip amount (or a portion thereof if the system is set to cap or otherwise prevent matching over a certain amount). The client's promotional code can be shared with other clients. Every time a different client utilizes the promotional code, the promotional code owner (i.e., original client generating the promotional code) will receive a credit into the promotional account via the system. One of ordinary skill in the art would appreciate that there are numerous types of promotional code methods that could be utilized with embodiments of the present invention, and embodiments of the present invention are contemplated for use with any appropriate promotional code method.

Service Provider Viewpoint

Continuing from above, beyond registration and being provided a unique code, a service provider may interact with the system in numerous ways. First, a service provider may utilize a mobile or other computing device to receive information and statuses related to tips received, reviews received, organizations associated with, ratings received, overall rating, historical averages, percentages (e.g., average tip percentage received) or other relevant tip information. One of ordinary skill in the art would appreciate that there are numerous information points and metrics that could be provided by the system, and embodiments of the present invention are contemplated for use with providing any appropriate information point or metric.

According to an embodiment of the present invention, the system may provide service providers with the ability to review their tips and information about how much they have been tipped in total. The tips received may be stored by the system until the service provider approves release of the tips to one or more financial accounts associated with the service provider. In certain embodiments, the system may take a fee or other cut of the tips provided prior to providing the tips to the service provider.

According to an embodiment of the present invention, the system may also allow service providers to share tips with other service providers. For instance, service providers who are waiters or waitresses may be provided the option to share tips with busboys, chefs, hostesses or hosts, or other associated individuals. In certain embodiments, the system may allow such service providers to setup automatic or default distribution of tips received, whether based on percentage of the total tip, specific amounts, or any combination thereof.

According to an embodiment of the present invention, the system may provide automatic updates to service providers when a tip is received. For instance, service providers who utilize mobile computing devices may receive a push notification or other notification when a tip is received from a client. The system may also provide notice when reviews, ratings or other transactions occur (e.g., tips transferred to financial account of service provider). One of ordinary skill in the art would appreciate that there are numerous methods and manners in which such notifications could be made, and embodiments of the present invention are contemplated for use with any appropriate notification method and means.

In certain embodiments, the system can also provide service providers the ability to rate and review tippers, whether anonymously or as identified by their registration information on the system. This user rating and review system may be provided to the clients or may be maintained solely for use by organizations and/or service providers for evaluating clients and or interactions with certain clients or clients in general.

In certain embodiments, the system can also provide service providers with additional services, such as tax calculation services and automatic withdrawal of tax amounts associated with tips for submission with a service provider's taxes. In this manner, the system can assist service providers with maintaining compliance with local, state, federal or international taxation requirements.

Advantageously, service providers are provided the ability to receive tips for services rendered, regardless of the status of payment for related goods and/or services. For instance, salons, pizza delivery services, spas and other establishments may have a fee that is paid directly to the establishment or organization without providing an easy method to tip a service provider unless the recipient of the service has cash. Even where the recipient may have cash, they may not have the correct denomination appropriate for a tip, leaving the recipient in a position where they either tip too much, too little or choose not to tip due to not having appropriate tip denomination in cash. By providing a method by which service providers can receive a tip independent of their organization, embodiments of the present invention establish a new and significant revenue source for these service providers.

Organization Viewpoint

According to an embodiment of the present invention, the system can provide organizations the ability to review their associated service providers at their convenience or in real-time or near real-time. As reviews and ratings are provided, the organization may be provided one or more GUIs or GUI information points allowing the organization to track and rate/review/rank service providers.

The system may allow for organizations to create divisions, subdivisions or other structures to appropriately organize their service providers. This allows organizations to monitor their various divisions based on ratings received within each division. For instance, a resort may have cleaning personnel, restaurant personnel, hotel personnel and other personnel that each may be service providers who receive tips and reviews via the system. The hotel can organize these personnel into different categories to see if particular categories are underperforming, outperforming or otherwise meeting desired criteria assigned by the organization.

Further, when a service provider or division receives a negative or other review or rating that does not meet or exceed levels specified by the organization, the organization may be notified immediately (e.g., push notification) so that the organization can take remedial action immediately. This may help organizations quickly respond to underperforming service providers and take action when necessary.

Conversely, when there is an outperforming division or service provider, the organization can reward that service provider. The system may be configured to allow an organization to reward such service providers through monetary means (e.g., payment via a payment source to a financial account of the service provider) or non-monetary means (e.g., provide recognitions or awards for achievement).

In certain embodiments, the system may be configured to integrate into a point of sale system for an organization and allow for payment of both the bill owed to the organization and tip to a related service provider in a single transaction. For instance, a point of sale system may be communicatively connected to the system and able to provide transaction information (e.g., transaction identifier, amount, service provider identifier) to the system (e.g., via an API). The point of sale system may then receive a unique identifier (e.g., QR code, alphanumeric code, barcode) from the system, from which the point of sale system will print the unique identifier on the bill or otherwise provide the unique identifier to the recipient of the service/goods. The client can then scan or otherwise enter the unique identifier onto their mobile device which will then retrieve the bill information from the system. The client can then pay both the bill and the tip via the mobile device. In certain embodiments, the system may be configured to provide suggested tip amount based on the bill total. In further embodiments, the system may allow the client to select a tip amount based on a varying percentage of the bill total (e.g. 10%, 15%, 20%), allowing the client to quickly adjust tip quickly and easily.

### Exemplary Embodiments

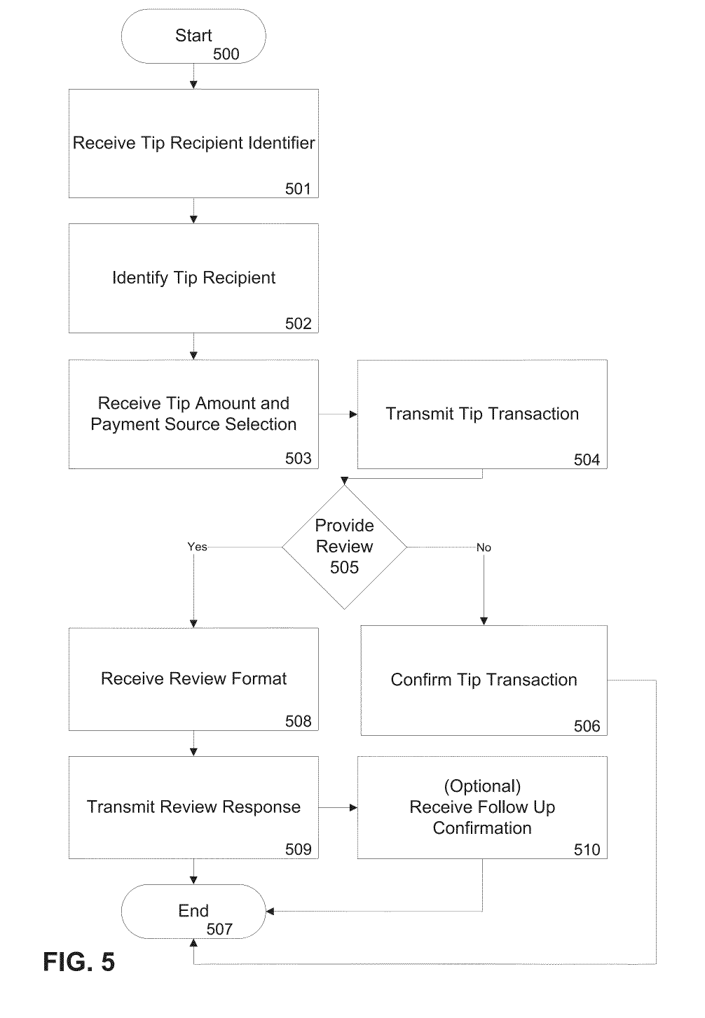

Turning now to FIG. 5, an exemplary embodiment of a method for providing tip and/or reviews via utilization of the system described herein is shown from the perspective of the mobile computing device. The process starts at step 500 with the client engaging his/her mobile computing device to commit a tip transaction request. At step 501, the mobile computing device receives a tip recipient identifier. This may be accomplished, for instance, via a camera on the computing device capturing a QR code or bar code provided by the service provider (e.g., on a business card or other media).

At step 502, the system identifies the tip recipient. This is generally accomplished by the transfer of the tip recipient identifier from the mobile computing device to the remote computing devices of the system for processing and retrieval of associated service provider information.

At step 503, assuming the service provider was properly identified, the user is prompted to enter a tip amount and select a payment source for payment of the tip. As noted above, the payment source selection may be from one that is stored by the system, stored by the mobile computing device of the user or entered manually by the user. The tip amount may be manually entered or the system can calculate the tip based on a total bill or portion of the price of the service rendered. The user can provide parameters to the calculation (e.g., select percentage of tip to leave). The total bill amount may be provided, for instance, by the user entering the total bill or the user may scan a bill or other informatics (e.g., QR code) that has the bill information associated with it.

At step 504, the client has entered all the relevant information needed to process the tip transaction and the mobile computing device transmits the tip transaction request to the system for processing. At this point, the system may prompt the user to provide a review of the service provider (step 505).

If the system does not provide for a review, the process moves to step 506 at which point the system confirms the tip transaction to the client via the mobile computing device and the process terminates at step 507.

If the system does provide for a review, the process moves to step 508 at which point the system retrieves a review format and transmits the review format to the mobile computing device of the client. The client then completes the review (at their leisure) at step 509. Optionally, for instance if the review of the service provider was poor, the system may allow for a follow up with the client in order to find out what occurred or otherwise re-engage the client (step 510). Either way, the process then terminates at step 507.

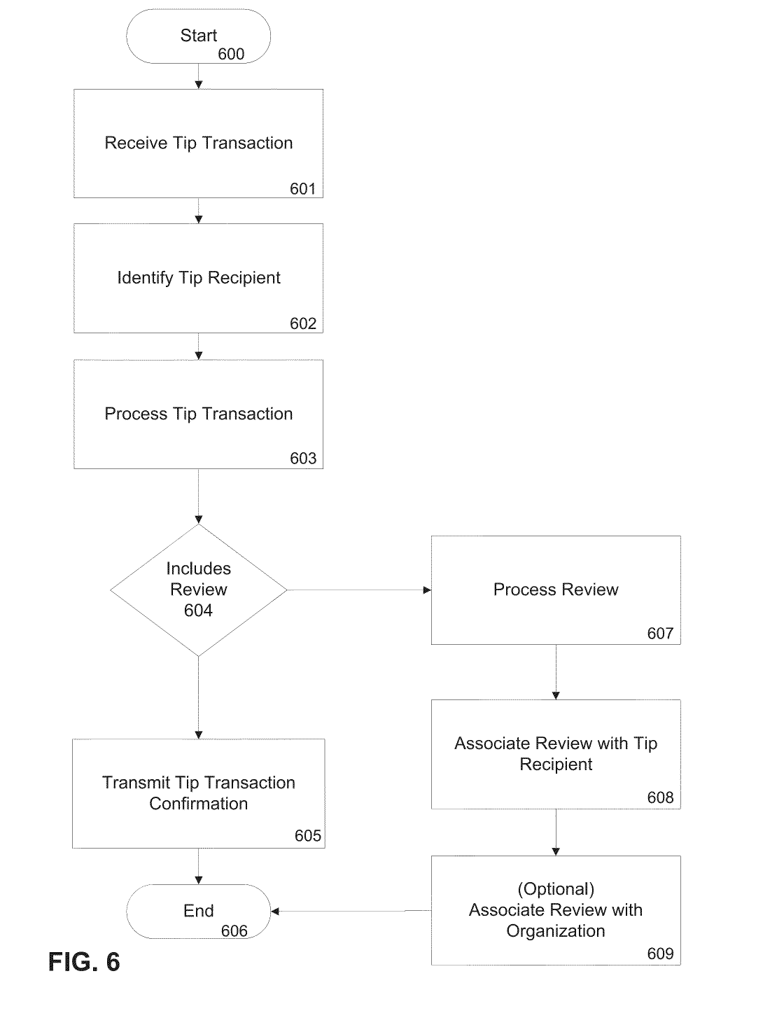

Turning now to FIG. 6, an exemplary embodiment of a method for providing tip and/or reviews via utilization of the system described herein is shown from the perspective of the system. The process starts at step 600 with a client submitting a tip transaction to a service provider. At step 601, the system receives the tip transaction request from a client. The system retrieves a tip recipient identifier from the tip transaction request and uses the identifier to identify a service provider associated with the tip transaction request (step 602).

At step 603, the system processes the tip transaction request and determines a tip amount and a payment source selection. As noted above, the payment source selection may be from one that is stored by the system, stored by the mobile computing device of the user or entered manually by the user. Processing of the tip transaction may include transmitting payment source information for confirmation to a third party provider, such as a merchant services provider for validation and confirmation of the payment source and availability of funds for the tip amount.

At step 604, the system determines if the tip transaction request includes or is associated with a service provider or organization that utilized reviews/ratings. If not, the system transmits a tip transaction confirmation to the client and/or service provider 605 and the process ends at step 606.

If the system determines a review or rating is included, the system processes the review portion of the transaction and associates the review and rating with the service providers/tip recipient at step 608. Optionally, if the service provider is associated with an organization, the system may associate the review and rating with the appropriate organization and/or division within the organization (step 609). In either event, the process then terminates at step 606.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing tips to service providers through non-cash means, the system comprising:
a tip processing module, comprising computer-executable code stored in non-volatile memory,
a communications module,
a processor,
one or more storage mediums,
wherein said tip processing module, said communications module, said processor, and said one or more storage mediums are operably connected and are configured to:
receive a tip transaction request from a mobile computing device;
retrieve a tip recipient identifier based on information contained in said transaction request;
identify a tip amount and a payment source based on information contained in said transaction request;
process a financial transaction on said payment source for the tip amount;
transfer funds to a payment account associated with said tip recipient identifier; and
send transaction confirmation to said mobile computing device.

2. The system of claim 1, wherein said tip processing module, said communications module, said processor, and said one or more storage mediums are further configured to:
retrieve an organization identifier associated with said tip recipient identifier;
retrieve a review format associated with said organization identifier;
provide said review format to said mobile computing device;
receive review response from said mobile computing device; and
associate said review response with said organization identifier and said tip recipient identifier.

3. The system of claim 2, wherein said tip processing module, said communications module, said processor, and said one or more storage mediums are further configured to:
generate a tip recipient review rating based in part on said review response, wherein said tip recipient review rating is a cumulative scoring based on a plurality of reviews received and associated with said tip recipient; and
provide said review rating to an account associated with said organization identifier.

4. The system of claim 1, wherein said tip processing module, said communications module, said processor, and said one or more storage mediums are further configured to transfer a portion of the tip amount to an operating account associated with the system.

5. The system of claim 1, wherein said tip processing module, said communications module, said processor, and said one or more storage mediums are further configured to:
generate a tax amount associated with said tip amount; and
deduct said tax amount from said tip amount prior to transferring funds.

6. The system of claim 1, wherein said tip processing module, said communications module, said processor, and said one or more storage mediums are further configured to provide historical transaction reporting to an account associated with said tip recipient identifier.

7. The system of claim 1, wherein said tip processing module, said communications module, said processor, and said one or more storage mediums are further configured to generate a unique code for said tip recipient identifier for use in identifying a tip recipient, wherein the unique code is selected from the group comprising a quick response code, a bar code, an alphanumeric code and a unique visual code.

8. A method for providing tips to service providers through non-cash means, the method comprising the steps of:
receiving a tip transaction request from a mobile computing device;
retrieving a tip recipient identifier based on information contained in said transaction request;
identifying a tip amount and a payment source based on information contained in said transaction request;
processing a financial transaction on said payment source for the tip amount;
transferring funds to a payment account associated with said tip recipient identifier; and
sending transaction confirmation to said mobile computing device.

9. The method of claim 8, further comprising the steps of:
retrieving an organization identifier associated with said tip recipient identifier;
retrieving a review format associated with said organization identifier;
providing said review format to said mobile computing device;
receiving review response from said mobile computing device; and
associating said review response with said organization identifier and said tip recipient identifier.

10. The method of claim 9, further comprising the steps of:
generating a tip recipient review rating based in part on said review response, wherein said tip recipient review rating is a cumulative scoring based on a plurality of reviews received and associated with said tip recipient; and
providing said review rating to an account associated with said organization identifier.

11. The method of claim 8, further comprising the step of transferring a portion of the tip amount to an operating account associated with the system.

12. The method of claim 8, further comprising the steps of:
generating a tax amount associated with said tip amount; and
deducting said tax amount from said tip amount prior to transferring funds.

13. The method of claim 8, further comprising the step of providing historical transaction reporting to an account associated with said tip recipient identifier.

14. The method of claim 8, further comprising the step of generating a unique code for said tip recipient identifier for use in identifying a tip recipient, wherein the unique code is selected from the group comprising a quick response code, a bar code, an alphanumeric code and a unique visual code.

15. A computer readable medium comprising computer executable instructions for instructing a processor to:
receive a tip transaction request from a mobile computing device;
retrieve a tip recipient identifier based on information contained in said transaction request;
identify a tip amount and a payment source based on information contained in said transaction request;
process a financial transaction on said payment source for the tip amount;
transfer funds to a payment account associated with said tip recipient identifier; and
send transaction confirmation to said mobile computing device.

16. The computer readable medium of claim 15, further comprising instructions for instructing a processor to:
retrieve an organization identifier associated with said tip recipient identifier;
retrieve a review format associated with said organization identifier;
provide said review format to said mobile computing device;
receive review response from said mobile computing device; and
associate said review response with said organization identifier and said tip recipient identifier.

17. The computer readable medium of claim 16, further comprising instructions for instructing a processor to:
generate a tip recipient review rating based in part on said review response, wherein said tip recipient review rating is a cumulative scoring based on a plurality of reviews received and associated with said tip recipient; and
provide said review rating to an account associated with said organization identifier.

18. The computer readable medium of claim 15, further comprising instructions for instructing a processor to transfer a portion of the tip amount to an operating account associated with the system.

19. The computer readable medium of claim 15, further comprising instructions for instructing a processor to:
generate a tax amount associated with said tip amount; and
deduct said tax amount from said tip amount prior to transferring funds.

20. The computer readable medium of claim 15, further comprising instructions for instructing a processor to generate a unique code for said tip recipient identifier for use in identifying a tip recipient, wherein the unique code is selected from the group comprising a quick response code, a bar code, an alphanumeric code and a unique visual code.
